(19) United States
(12) Patent Application Publication
(10) Pub. No.: US 2006/0173664 A1
(43) Pub. Date: Aug. 3, 2006

(54) SAN modeling

(76) Inventors: Suban Krishnamoorthy, Shrewsbury, MA (US); Vijayender Garcha, Northborough, MA (US); Christopher Stroberger, Colorado Springs, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/045,515

(22) Filed: Jan. 31, 2005

(51) Int. Cl. G06F 17/50

(52) U.S. Cl. 703/13

(57) ABSTRACT

A method, of modeling a storage system that includes an interconnected plurality of devices where there is at least one instance of a multi-link rather than a single-link between two of the plurality of devices, may include: providing a snapshot of the storage system (SSshot); decomposing multi-links of the SSshot into single-link-based arrangements, respectively; associating the single-link-based arrangements with the multi-links, respectively; and modeling the storage system as a graph of singly-linked nodes based upon the SSshot and the associated single-link-based arrangements, where nodes of the graph correspond to the plurality of devices.

### BACKGROUND OF THE PRESENT INVENTION

Storage systems, e.g., storage area networks (SANs), are specialized networks of interconnected devices that typically include heterogeneous devices, such as servers with Host Bus Adapters (HBAs), storage arrays, management system(s), and interconnect devices such as switches, bridges, routers, etc. The various devices included in a SAN typically are provided by a variety of manufacturers. A roster of the interconnected devices is typically maintained by inventorying each device on the network. This can include using automated survey software on each device to help collect information regarding the hardware components of each device and the other software loaded thereon.

In the field of file system backup, it is a known technique to take a snapshot of the file system at different times and then compare the file-system-snapshots to determine changes that might have occurred. Such a technique is used to compare file-system-snapshots within a SAN.

In the field of VLSI and ULSI design, it is known to compare integrated circuits as follows: the integrated circuits are modeled using graph theory; and then their models are compared to determine whether the models are isomorphic. Isomorphic structures are treated as being the same at some level of abstraction. Two structures can be considered isomorphic if, when the specific identities of the elements in the underlying sets are ignored, focusing just on the structures themselves finds the structures to be identical. For example, some simple examples of isomorphic structures are: a solid cube made of wood and a solid cube made of lead because their geometric structures are identical though their matter differs; a standard deck of 52 playing cards with green backs and a standard deck of 52 playing cards with brown backs because their organization and component parts are identical though the colors on the backs of each deck differ (if it is desired to play cards, it matters not which deck is used); and London's Big Ben and an analog wristwatch because their representations of elapsing time are identical though the clocks vary greatly in size and time-keeping mechanisms.

### SUMMARY OF THE PRESENT INVENTION

At least one embodiment of the present invention provides a method of modeling a storage system that includes an interconnected plurality of devices, there being at least one instance of a multi-link rather than a single-link between two of the plurality of devices. Such a method may include: providing a snapshot of the storage system (SSshot); decomposing multi-links of the SSshot into single-link-based arrangements, respectively; associating the single-link-based arrangements with the multi-links, respectively; and modeling the storage system as a graph of singly-linked nodes based upon the SSshot and the associated single-link-based arrangements, where nodes of the graph correspond to the plurality of devices.

Additional features and advantages of the present invention will be more fully apparent from the following detailed description of example embodiments, the accompanying drawings and the associated claims.

### BRIEF DESCRIPTION OF THE DRAWINGS

The drawings are: intended to depict example embodiments of the present invention and should not be interpreted to limit the scope thereof. In particular, relative sizes of the components of a figure may be reduced or exaggerated for clarity. In other words, the figures are not drawn to scale.

FIG. 1 depicts a block diagram of a system of networks, to which one or more SS-analysis (storage-system analysis) embodiments of the present invention can be applied.

FIG. 2 is a block diagram showing the analysis unit of FIG. 1 in more detail, according to at least one embodiment of the present invention.

FIG. 3A depicts a method of modeling a SAN, where the SAN includes at least one instance of a multi-link rather than a single-link between two of the plurality of devices that comprise the SAN, according to at least one embodiment of the present invention.

FIG. 3B depicts the decomposing block of the method of FIG. 3A in more detail, according to at least one embodiment of the present invention.

FIG. 3C depicts the decomposing block of the method of FIG. 3A in more detail, according to at least one other embodiment of the present invention.

FIG. 4A is a block diagram depiction of the decomposition of FIG. 3B, according to at least one embodiment of the present invention.

FIG. 4B is a block diagram depiction of the decomposition of FIG. 3C, according to at least one embodiment of the present invention.

FIG. 5 is a flowchart depicting a method of comparing a first snapshot of a storage system and a second snapshot of the same storage system, according to at least one embodiment of the present invention.

FIG. 6 is a flowchart depicting a method of comparing a first snapshot of a storage system and a second snapshot of a replication of the storage system, according to at least one embodiment of the present invention.

FIG. 7 is a flowchart depicting yet another method of comparing a first snapshot of a first storage system and a second snapshot of a second storage, according to at least one other embodiment of the present invention.

FIG. 8 is a flowchart depicting a method of comparing a snapshot against a recommended storage-system-architecture, according to at least one other embodiment of the present invention.

### DETAILED DESCRIPTION OF EXAMPLE EMBODIMENTS

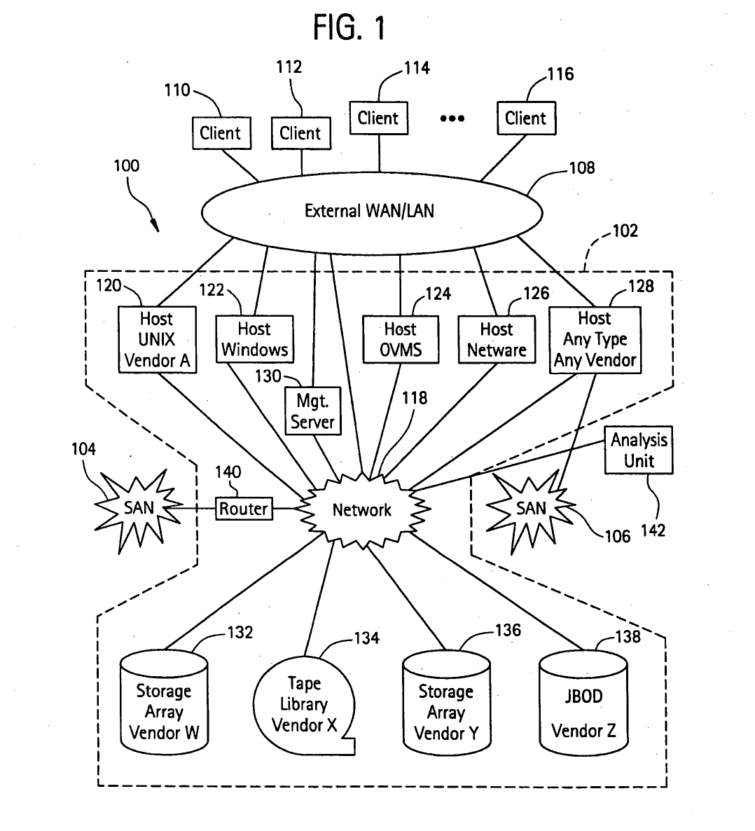

FIG. 1 depicts a block diagram of a system 100 of networks, to which one or more SS-analysis (storage-system analysis) embodiments of the present invention can be applied.

System 100 can include: multiple storage systems 102, 104 and 106, e.g., storage area networks (again, SANs); an external WAN/LAN 108; and clients 110-116 connected to WAN/LAN 108. SAN 102 includes an interconnected plurality of devices, at least some of which provide storage space. Clients 110-116 consume storage space provided by SAN 102. SANs 104 and 106 can include components similar to SAN 102.

SAN 102 can include: a networking infrastructure 118; hosts 120-128 connected between networking infrastructure 118 and WAN/LAN 108, respectively; a management server 130 connected between networking infrastructure 118 and WAN/LAN 108; storage resources 132-138 connected to networking infrastructure 118; and a router 140 connected between networking infrastructure 118 and SAN 104. Host 128 also is connected to SAN 106.

The components of SAN 102 depicted in FIG. 1 are but one example of the variety of components that typically can be found in a SAN. To help illustrate that variety, some fictional characteristics of hosts 120-128 and storage resources 132-138 are assumed. More particularly, it assumed that: host 120 runs the UNIX operating system and is provided by a vendor A; host 122 runs one of the Windows® operating systems; host 124 runs the OpenVMS (OVMS) operating system; host 126 runs the Netware® operating system; host 128 runs any type of operating system and is provided by any vendor; storage resource 132 is a storage array provided by a vendor W; storage resource 134 is a tape library provided by a vendor X; storage resource 136 is a storage array provided by a vendor Y; and storage resource 138 is a JBOD (just a bunch of disks) provided by a vendor Z.

As noted, one or more SS-analysis embodiments of the present invention can be applied to system 100. Such one or more embodiments can be hosted, for example, on management server 130, which is internal to SAN 102. Alternatively, such one or more embodiments can be hosted, for example, on an analysis unit 142 external to SAN 102. Each of management server 130 and analysis unit 142 can be a typical computer that, for example, can include: at least one CPU; at least one input device; at least one output device; volatile memory such as RAM; and non-volatile memory such as ROM, flash memory, disc drives, tape drives, etc.

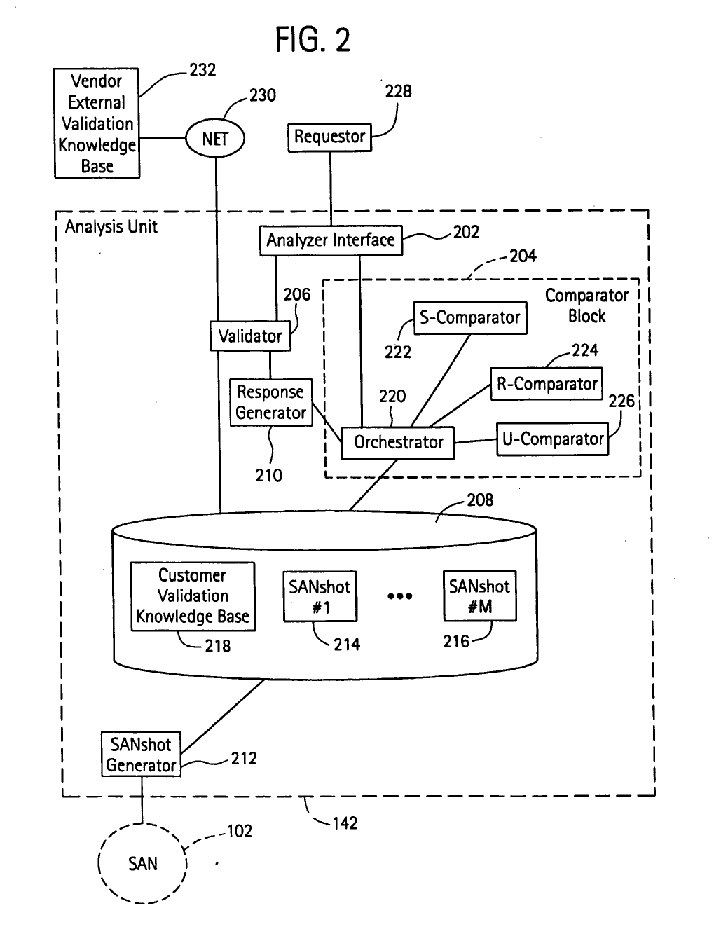

For simplicity of illustration, it will be assumed that one or more of the SS-analysis embodiments of the present invention are hosted on analysis unit 142. FIG. 2 is a block diagram showing analysis unit 142 in more detail, according to at least one embodiment of the present invention.

Analysis unit 142 can include: an analyzer interface 202; a comparator block; 204; a validator unit 206; a database 208; a response generator 210; and a snapshot generator 212 to generate a snapshot of storage system 102 (SSshot). Where storage system 102 is a SAN, then a snapshot thereof can be referred to as a SANshot. Comparator block 204 can include: an orchestrator unit 220; an S-comparator 222; an R-comparator 224; and a U-comparator 226. The components of comparator block 204 will be discussed in more detail below.

Data stored in database 208 can include: one through M SANshots 214, . . . ,216, respectively of SAN 102; and a customer validation knowledge base 218. The latter, knowledge base 218, can be stored in database 208 by validator unit 206, which can obtain the same externally from a vendor's validation knowledge base 232 via a networking infrastructure 230, e.g., the world wide web.

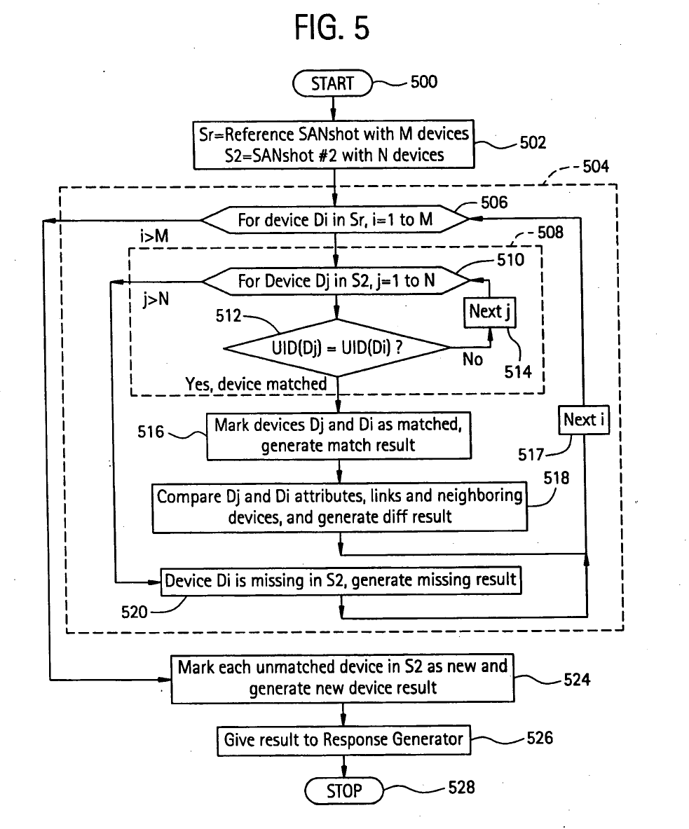

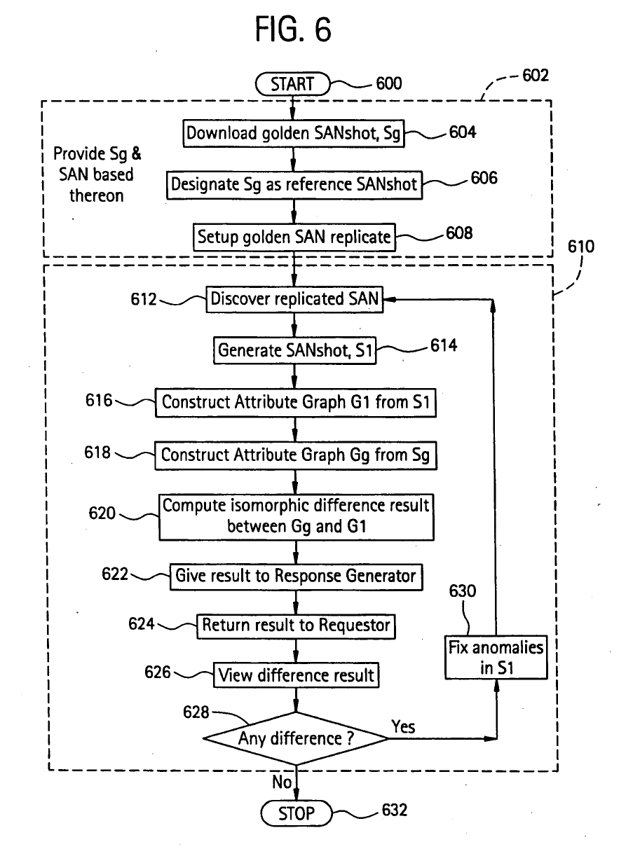

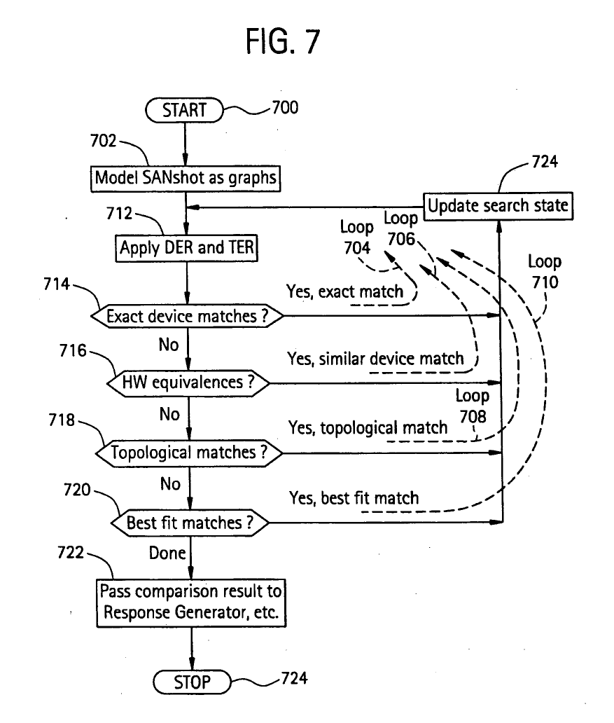

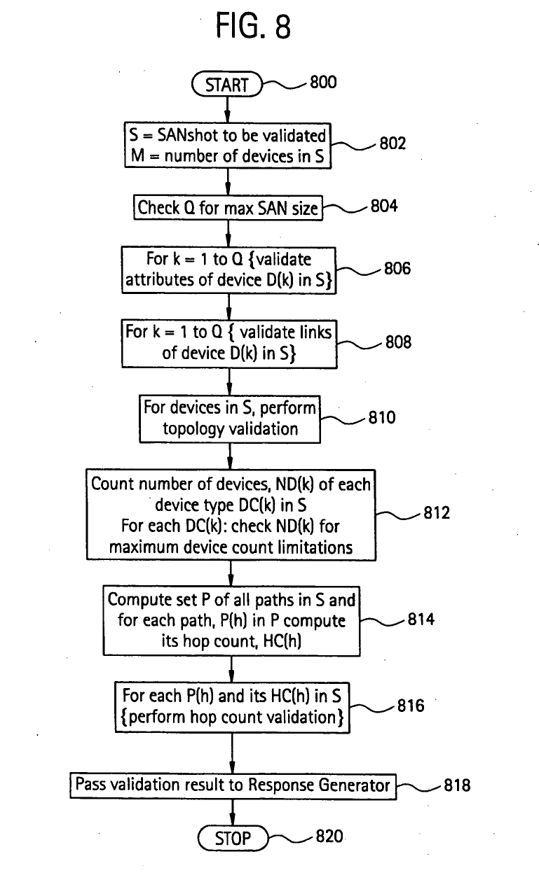

An administrator wishing to make an SS-analysis of SAN 102 can submit an analysis-request to analyzer interface 202. In such a circumstance, the administrator can be considered to be requester 228. The administrator might make such a request in order to: compare how SAN 102 has changed over time since inception or since the last analysis, which would involve S-comparator 222 and the methodology of FIG. 5 (to be discussed in more detail below); compare an initial setup of SAN 102 against a reference SAN-setup, which would involve R-comparator 224 and the methodology of FIG. 6 (to be discussed in more detail below); compare a SANshot of SAN 102 against a SANshot of a different (or, in other words, unrelated) SAN, e.g., SAN 104 or 106, which would involve U-comparator 226 and the methodology of FIG. 7 (to be discussed in more detail below); verify that an initial setup of SAN 102 conforms to the general guidelines and restrictions established by the vendor of the SAN, which would involve validator unit 206 and the methodology of FIG. 8 (to be discussed in more detail below); etc.

Whatever the reason for the analysis request, one of S-comparator 222, R-comparator 224, U-comparator 226 and validator 204 can perform the analysis and response generator 210 can generate a response based upon the analysis, respectively. Each of S-comparator 222, R-comparator 224, U-comparator 226 and validator 204 can model SAN 102 as part of the respective analysis.

In the Background Art, the graph-theory-based isomorphism (again, a comparison technique based upon graph theory modeling) is relatively simple because, e.g., the components to be modeled have only single links therebetween, all nodes are treated as being the same and thus no consideration is given to attributes of the nodes, etc. In contrast, however, SANs can have two or more components with multiple links therebetween. At least one embodiment of the present invention provides a method of modeling a SAN where the SAN includes at least one instance of a multi-link rather than a single-link between two of the plurality of devices that comprise the SAN. Further in contrast, SANs typically have nodes that possess a variety of attributes, e.g., the unique identification (UID) (unique at least within the SAN), the type of device which the node represents, the manufacturer of the device, the model number of the device, the version of software loaded on the device, etc. It can be advantageous to be able to determine, e.g., that two devices which correspond topologically have the same/different manufactures, model numbers, etc.

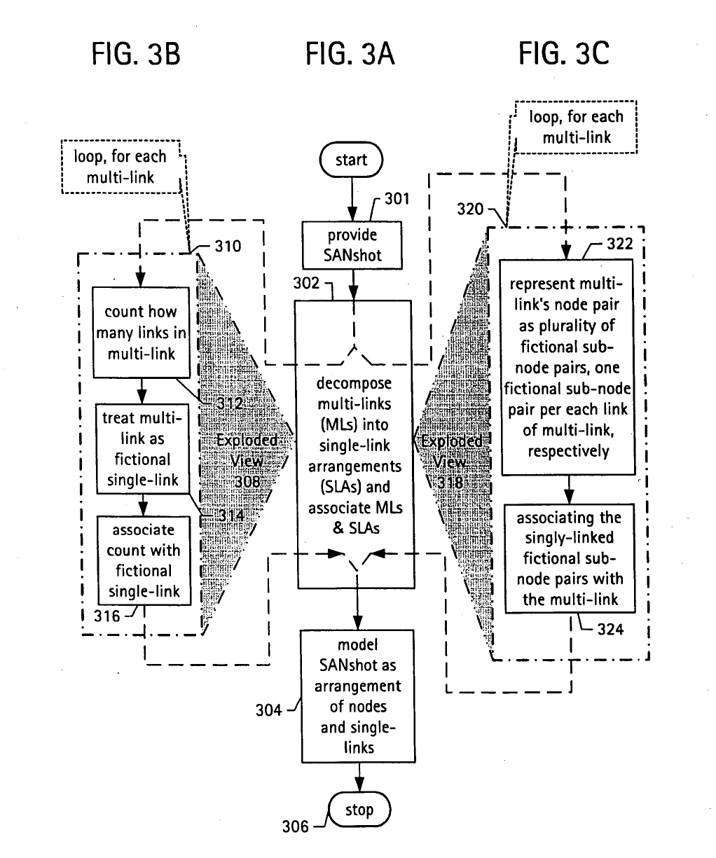

FIG. 3A depicts a method of modeling a SAN, where the SAN includes at least one instance of a multi-link rather than a single-link between two of the plurality of devices that comprise the SAN, according to at least one embodiment of the present invention. Such a method can be carried out, e.g., by any one of S-comparator 222, R-comparator 224, U-comparator 226 and validator 204.

In FIG. 3A, flow begins at start block 300 and proceeds to block 301, where a SANshot is provided. Flow proceeds to block 302, where each of the multi-links in the SANshot are determined, then decomposed into single-link-based arrangements, respectively, and the single-link-based arrangements are associated with the corresponding multi-links. Flow then proceeds to block 304, where the SANshot is modeled according to graph-theory as an arrangement of nodes and single-links therebetween, respectively, based upon the SANshot and the associated single-link-based arrangements. The nodes of such a graph correspond to the plurality of interconnected devices in the SAN.

FIG. 3B depicts decomposing block 302 of FIG. 3A in more detail as exploded view 308, according to at least one embodiment of the present invention. Again, such a method can be carried out, e.g., by any one of S-comparator 222, R-comparator 224, U-comparator 226 and validator 204.

In exploded view 308, flow proceeds into a loop 310 from block 301. Loop 310 is repeated for each multi-link in the SANshot. Within loop 310, flow proceeds first to block 312, where a count is made of the number of links in the given multi-link. Flow proceeds to block 314, where the given multi-link can be treated as a fictional single-link. Then flow proceeds to block 316, where the count of the given multi-link is associated with the given fictional single-link. If another iteration of loop 310 is not needed, then flow can proceed from block 316 to block 304 (discussed above).

It is noted that the blocks of FIGS. 3A, 3B and 3C can be performed automatically.

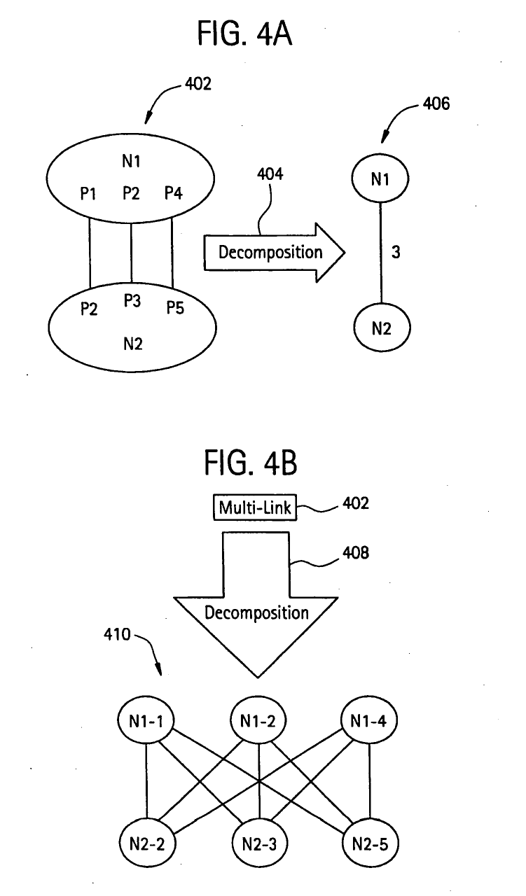

FIG. 4A is a block diagram depiction of the decomposition of FIG. 3B, according to at least one embodiment of the present invention.

In FIG. 4A, a multi-link 402 is depicted as nodes N1 and N2 having, e.g., three links: a first link between port P1 of node N1 and port P2 of node N2; a second link between port P2 of node N1 and port P3 of node N2; and a third link between port P4 of node N1 and port P5 of node N2. After decomposition (arrow 404, corresponding to exploded view 308), multi-link 402 is depicted as a fictional single-link 406, with which is associated a count, here COUNT=3. It should be understood that a fictional number of links and fictional port numbers have been selected in FIG. 4A to enhance the discussion; other numbers of links and alternative port numbering are contemplated.

FIG. 3C depicts decomposing block 302 of FIG. 3A in more detail as exploded view 318, according to at least one other embodiment of the present invention. FIG. 3C is an alternative to FIG. 3B. Again, such a method can be carried out, e.g., by any one of S-comparator 222, R-comparator 224, U-comparator 226 and validator 204.

In exploded view 318, flow proceeds into a loop 320 from block 301. Loop 320 is repeated for each multi-link in the SANshot. Within loop 320, flow proceeds first to block 322. A multi-link connects a pair of nodes with multiple links. In block 322, a given pair of nodes connected by the given multi-link becomes represented as a plurality of pairs of fictional sub-nodes, where each link of the multi-link is allotted to one of the plurality of fictional sub-node pairs, respectively, and where each pair of the fictional sub-nodes has a single-link therebetween. Flow proceeds to block 324, where the singly-linked fictional sub-node pairs are associated with the given multi-link. If another iteration of loop 320 is not needed, then flow can proceed from block 324 to block 304 (discussed above).

FIG. 4B is a block diagram depiction of the decomposition of FIG. 3C, according to at least one embodiment of the present invention.

In FIG. 4B, multi-link 402 (as shown in FIG. 4A) is decomposed (arrow 408, corresponding to exploded view 318) into a plurality 410 of singly-linked fictional sub-node pairs. Plurality 410 of singly-linked sub-node pairs includes the sub-nodes: N1-1 and N2-2; N1-1 and N2-3; N1-1 N2-5; N1-2 and N2-2; N1-2 and N2-3; N1-2 and N2-5; N1-4 and N2-2; N1-4 and N2-3; and N1-4 and N2-5. As with FIG. 4A, it should be understood that a fictional number of links and corresponding sub-node pairs have been selected in FIG. 4B to enhance the discussion; other numbers of links and corresponding sub-node pairs are contemplated.

Operation of S-comparator 222, R-comparator 224, U-comparator 226 and validator 204 will now be discussed, in that order beginning with S-comparator 222.

FIG. 5 is a flowchart depicting a method of comparing a first SANshot and a second SANshot, according to at least one embodiment of the present invention.

For example, the flowchart of FIG. 5 can be used in a circumstance in which the first SANshot and the second SANshot are of the same SAN, e.g., SAN 102, and the second SANshot is taken later in time relative to the first SANshot. Such a comparison as is depicted in FIG. 5 would be carried out, e.g., by S-comparator 222.

FIG. 5 assumes that SAN 102 includes an interconnected first plurality of devices as of when the first SANshot is taken and an interconnected second plurality of devices as of when the second SANshot is taken. The second plurality can be the same as the first plurality, but typically will not be the same, e.g., because of the passage of time. Also, each device in the first and second pluralities thereof has a unique identification (again, UID) associated with it.

In FIG. 5, flow begins at block 500 and proceeds to block 502, where: the first SANshot is treated as a reference SANshot, Sr, that includes M devices; and the second SANshot, S2, is treated as including N devices. Flow proceeds to an outer loop 504, more particularly to decision block 506 therein. Each iteration of loop 504 considers device Di in the SANshot Sr, for 1≦i≦M, where i and M are positive integers, and M is the total number of interconnected devices in the SANshot Sr. Decision block 506 represents both the entrance and exit of loop 504. If 1≦i≦M, then flow proceeds further inside loop 504 to an inner loop 508. But if i>M, then flow exits loop 504 and proceeds to block 524 (to be discussed below).

If flow proceeds from decision block 506 to loop 508, it first arrives within loop 508 at decision block 510. Each iteration of loop 510 considers device Dj in the SANshot S2, for 1≦j≦N, where j and N are positive integers, and N is the total number of interconnected devices in the SANshot S2. Decision block 510 represents both the entrance and exit of loop 510. If 1≦j≦N, then flow proceeds further inside loop 510 to decision block 512 (to be discussed below). But if j>N, then flow exits loop 510 to block 520 (to be discussed below).

At decision block 512, it is automatically determined whether the UID for device Dj, UID(Dj), is the same as the UID for device Di, UID(Di), namely

UID(Dj)=UID(Di).

If not (i.e., if UID(Dj)≠UID(Di), then flow proceeds to block 514, where j is incremented. After block 514, flow loops back to decision block 510. But if so (i.e., if UID(Dj)=UID(Di), then flow exits loop 508 and proceeds to block 516, where devices Dj and Di are automatically associated as matching and a matching-device result automatically can be generated. Flow proceeds from block 516 to block 518.

At block 518, at least one of the following pairings of criteria automatically can be compared: hardware and/or software attributes of devices Dj and Di; links between devices Dj and Di; and devices that are neighbors to devices Dj and Di. Each link between devices Dj and Di can be viewed as connecting: a domestic port of a domestic device within the SANshot Sr that corresponds to UID; and a counterpart port of a counterpart device within the SANshot S2 that corresponds to the UID.

Comparison of attributes can be done, more particularly, for example, in terms of hardware type, hardware manufacturer identification, hardware model number, software version/revision numbers, software version/revision dates, etc. Comparison of the domestic and counterpart ports can be done, more particularly, for example, in terms of port type (e.g., a standard TCP/IP port, an F-port (fabric port), an N-port (node port), etc.) and/or the respective port's number. Comparison of neighbor devices can be done, more particularly, for example, in terms of the neighbors': UIDs; port types; port numbers; software version/revision numbers, software version/revision dates, etc. Differences are identified and recorded, and a device-difference result can be generated.

Flow can proceed from block 518 to block 519, where i is incremented at block 519. After block 519, flow loops back to decision block 506. As noted above, if it is determined at decision block 510 that j>N, then flow exits loop 508 and proceeds to block 520. There, device Di in the SANshot Sr automatically is marked as missing from the SANshot S2 and a missing-device result automatically can be generated. Flow can proceed from block 520 to block 519 (discussed above) and then (again) loops back to decision block 506.

As noted above, if it is determined at decision block 506 that i>M, then flow exits loop 504 and proceeds to block 524. There, any unmatched device in the SANshot S2 automatically is marked as a new device, and a new-device result can be generated. Flow proceeds to block 526, where the various results are provided automatically to response generator 210. The various results can be described generally as isomorphic difference results and, again, can include one or more of the following; matching-device results; device-difference results; missing-device results; and new-device results. Response generator 210 automatically can generate an output to requester 228 that is indicative (via text and/or graphics) of the various results of the comparison.

FIG. 6 is a flowchart depicting another method of comparing a first SANshot and a second SANshot, according to at least one other embodiment of the present invention.

For example, the flowchart of FIG. 6 can be used in a circumstance in which the first SANshot (Sg) is of a SAN whose setup has been carefully tuned (which can be referred to as a golden SAN) and another SANshot (S1) of another SAN (e.g., SAN 102) for which it has been attempted to replicate the setup of the golden SAN. Such a comparison as is depicted in FIG. 6 would be carried out, e.g., by R-comparator 224.

In FIG. 6, flow begins at block 600 and proceeds to block 602, where the golden SANshot Sg and the SAN that is a replication thereof are provided. More particularly, block 602 can include blocks 604-606. Inside block 602, flow can first proceed to block 604, where the golden SANshot Sg is obtained, e.g., by orchestrator 220 downloading it from requester 228 via analyzer interface 202 and storing it in database 208. Flow proceeds to block 606, where R-comparator can designate the golden SANshot Sg as the reference against which a comparison will be made. Next, at block 608, a SAN (e.g., SAN 102) can be constructed that is intended to be a replication of Sg. Flow can exit block 602 after it leaves block 608, and can proceed to loop 610.

Loop 610 is repeated until differences between Sg and S1 (again, the SANshot of the replication of the golden SAN) can no longer be determined. Within loop 610, flow proceeds first to block 612, where the interconnected devices that comprise SAN 102 automatically are discovered. Flow proceeds to block 614, where the SANshot S1 automatically is taken, e.g., by SANshot generator 212. The SANshot S1 can be considered the first SANshot relative to the golden SANshot Sg, which can be considered a second one of the two SANshots involved in the comparison. Flow then proceeds to block 616 and then to block 618.

At block 616, the SANshot S1 automatically is modeled to produce a first graph G1. At block 618, the golden SANshot Sg automatically is modeled to produce a second graph Gg. Such modeling can be, e.g., as described above. Again, for example, for the respective SANshots, the following can be performed automatically: the multi-links (if any) in the respective SANshots are determined, decomposed into single-link arrangements and associations therebetween made; and then the SANshot is modeled according to graph-theory based upon the SANshot and the associated single-link-based arrangements. Flow proceeds to block 620.

At block 620, a comparison is made automatically between Gg and G1 to determine isomorphic difference results, e.g., see the discussion above regarding FIG. 4. Flow proceeds to block 622, where the isomorphic difference results automatically can be provided to response generator 210. Flow proceeds to block 624, where response generator 210 automatically can generate a response that is indicative of the isomorphic difference results and provide it to requestor 228. Flow proceeds to block 626.

At block 626, requester 228 can view the response provided by response generator 210. Flow proceeds to decision block 628, where it is determined if the response actually indicates the existence of differences. If not (i.e., no differences are indicated), then SAN 102 is considered to replicate the golden SAN according to whatever degree of sameness has been established as representing an absence of differences. As such, flow would proceed to block 632 and stop.

If however, it is determined at decision block 628 that differences exist, then flow can proceed to block 630, where changes can be made to SAN 102 that are considered to be likely to resolve the differences. At this point in time, SAN 102 is sufficiently different that the comparison should be redone. Accordingly, flow proceeds from block 630 and loops back to block 612 (discussed above). As a practical matter, the changes made at block 630 typically will not resolve all differences the first time that flow passes through block 630, e.g., because the changes will be made imprecisely, or there could be so many potential changes that initially only a subset thereof will be made, etc. As such, typically there will be two or more iterations of loop 610.

FIG. 7 is a flowchart depicting yet another method of comparing a first SANshot and a second SANshot, according to at least one other embodiment of the present invention.

For example, the flowchart of FIG. 7 can be used in a circumstance in which the first SANshot and the second SANshot are of different and unrelated SANs, e.g., SAN 102 and one of SANs 106 & 106. While the flowcharts of FIGS. 5 and 6 determine differences in SANshots, the subject SANs of the flowcharts of FIGS. 5 and 6 can be considered related. A comparison such as depicted by the flowchart of FIG. 7 would be carried out, e.g., by U-comparator 226.

FIG. 7 assumes that SAN 102 (again, the first SAN) includes an interconnected first plurality of devices and the second SAN includes an interconnected second plurality of devices. The first and second SAN shots can be taken at the same or at different times. In addition, FIG. 7 assumes that the first and second SANshots include, or are associated with, data representing hardware (and/or software) attributes of the respective first and second pluralities of devices.

In FIG. 7, flow begins at block 700 and proceeds to block 702, where the first and second SANshots automatically are modeled as graphs, e.g., as discussed above regarding blocks 616 and 618 of FIG. 6. Flow proceeds from block 712 into a set of nested loops 704-710, where loop 704 is nested within loop 706, loop 706 is nested within loop 708, and loop 708 is nested within loop 710. Within each of loops 704-710, flow first proceeds to block 712.

At block 712, DERs (device equivalence rules) and TERs (topology equivalence rules) automatically are applied to the first and second SANshots. The DERs and TERs have quality rating values associated therewith. If a DER and/or a TER is found to be true for a device under consideration, then the quality rating value of the DER and/or TER is/are added to an overall quality rating value for the device.

The DERs are used to assess the degree to which hardware and/or software attributes of the devices in SAN 102 compare with hardware and/or software attributes of the devices in the second SAN. Examples of DERs (for a pair defined as a device in SAN 102 and a device in the second SAN) can include:
whether the two devices are of the same type (referred to as a type-match);
whether, for two devices that are a type-match, the manufacturers are the same (referred to as a type_&_same_manufacturer match);
whether, for two devices that are a type_&_same_manufacturer match, the model designations are the same (referred to as a type_&_same_manufacturer_&_same_model match);
whether, for two devices that are a type_&_same_manufacturer_&_same_model match, the software revisions are the same (referred to as a type &_same_manufacturer_&_same_model & same_rev match);
whether, for two devices that are a type_&_same_manufacturer match but whose model designations do not match, the model designations are present on a list of comparable model designations (referred to as a type_&_same_manufacturer_&_comparable_model match);
whether, for two devices that are a type-match but whose manufacturers do not match, the model designations are present on a list of comparable model designations by other manufacturers (referred to as a type_&_other_manufacturer_&_comparable_model match);
etc.

The TERs are used to assess the degree to which a device in SAN 102 performs the same role (as indirectly indicated via the particular topology of the device within the SAN) as a device within the second SAN. Each link can be viewed as connecting a domestic port and a counterpart port. The domestic port can be a port on a domestic device, where the domestic device is the device under consideration. The counterpart port can be a port on a counterpart device to which the domestic device is connected via the link. Examples of TERs (for a pair, again, defined as a device in SAN 102 and a device in the second SAN) can include:
whether the two domestic devices have the same number of links;
whether the two domestic devices have the same counterpart devices;
whether the two domestic devices have the same number of ports;
whether the numbers assigned to the ports of the two domestic devices are the same;
whether the types of the ports of the two domestic devices are the same;
whether identifications of the counterpart devices for the two domestic devices are the same;
whether the numbers assigned to the counterpart ports of the counterpart devices (relative to the two domestic devices) are the same;
etc.

The quality rating value of a TER can depend, e.g., generally upon a weighting among categories of parameters, and specifically upon and those parameter categories to which the TER applies. Example parameter categories include: the number of links exhibited by a device; domestic port type; the number assigned to a domestic port; counterpart device identification; the number assigned to a counterpart port; etc.

Returning to the discussion of flow within FIG. 7, flow proceeds from block 712 to decision block 714. There, it is determined automatically whether there are any exact device matches between the first and second pluralities of devices. The quality rating value that must be attained to be considered a match will vary, e.g., depending upon the objectives of the requester, the circumstances in which the desire for such an assessment arises, etc. For example, an exact match can be declared when a type_&_same_manufacturer_&_same_model match is found, or when a type_&_same_manufacturer_&_same_model_&_same_rev match is found.

If any exact matches are found at decision block 714, then flow proceeds to block 724, where the search state is updated automatically. This can include, e.g., removing the devices (from the respective pluralities thereof) that exactly match and thus precluding the exactly-matching devices from further application of the DERs and TERs. From block 724, flow loops back to block 712. There, the DERs and TERs are again applied, albeit to the respective now-reduced pluralities of devices. Flow proceeds to decision block 714, but this time there will be no exact matches, so flow proceeds (or, in other words, falls through) to decision block 716.

At decision block 716, it is determined automatically if there are any devices in the first and second pluralities thereof that are considered to be hardware equivalents. The quality value of a hardware equivalence match is less than for an exact match. For example, a hardware match can be declared when a type_&_same_manufacturer_&_comparable_model match is found, or when a ype_&_other_manufacturer_&_comparable_model match is found.

If any hardware equivalence matches are found at decision block 716, then flow proceeds to block 724, where (again) the search state is updated automatically. This can include, e.g., removing the devices (from the respective pluralities thereof) that are considered hardware equivalence matches and thus precluding them from further application of the DERs and TERs. From block 724, flow loops back to block 712. There, the DERs and TERs are again applied, albeit to the respective further reduced pluralities of devices. Flow proceeds to but falls through decision block 714 (because again this time there will be no exact matches), and then to decision block 716, but this time there will be no hardware equivalence matches, so flow falls through to decision block 718.

At decision block 718, it is determined automatically if there are any devices in the first and second pluralities thereof that are considered to be topological matches. The quality value of topological match is less than for an exact match, and can be (but is not necessarily less) than a hardware equivalence match. For example, a topological match can be declared when: the two domestic devices have the same number of links; the two domestic devices have (1) the same number of links and (2) the same counterpart devices or the numbers assigned to the counterpart ports of the counterpart devices are the same; etc.

If any topological matches are found at decision block 718, then flow proceeds to block 724, where (again) the search state is updated automatically. This can include, e.g., removing the devices (from the respective pluralities thereof) that are considered topological matches and thus precluding them from further application of the DERs and TERs. From block 724, flow loops back to block 712. There, the DERs and TERs are again applied, albeit to the respective yet further reduced pluralities of devices. Flow proceeds to but falls through decision block 714 (because again this time there will be no exact matches), then proceeds to but falls through decision block 716 (because again this time there will be no hardware equivalence matches), then proceeds to but falls through decision block 718 (because this time there will be no topological matches) to decision block 720.

At decision block 720, it is determined automatically if there are any devices in the first and second pluralities thereof that are considered to be best fit matches, or (in other words) matches of a quality rating value less than a hardware equivalence match and/or a topological match yet nevertheless rising above a minimum quality value threshold. For example, a topological match can be declared when: the two domestic devices are of the same type and have dissimilar numbers of links, but certain ones of the links have matching port types and/or port numbers and comparable counterpart devices.

If any best fit matches are found at decision block 720, then flow proceeds to block 724, where (again) the search state is updated automatically. This can include, e.g., removing the devices (from the respective pluralities thereof that are considered best fit matches and thus precluding them from further application of the DERs and TERs. From block 724, flow loops back to block 712. There, the DERs and TERs are again applied, albeit to the respective still further reduced pluralities of devices. Flow proceeds to but falls through decision blocks 714 and 716, then proceeds to but falls through decision block 718 (because again this time there will be no topological matches), and then proceeds to but falls through decision block 716 (because this time there will be no best fit matches), and then proceeds to block 722. At block 722, the match results automatically are provided to response generator 210, etc. Flow proceeds to block 726 and stops.

Relative to FIG. 7, it should be understood that other additional or other DERs and/or TERs are contemplated, and that DERs and/or TERs will vary, e.g., depending upon the objectives of the requester, the circumstances in which the desire for such an assessment arises, etc.

FIG. 8 is a flowchart depicting a method of comparing a SANshot against a recommended SAN architecture, according to at least one other embodiment of the present invention.

For example, the flowchart of FIG. 8 can be used in a circumstance in which a vendor of a SAN provides a list of recommended component devices, hardware and/or software attributes thereof and interconnection recommendations (in terms of link parameters). While the flowchart of FIG. 8 determines differences between a desired golden SANshot and a SANshot of a replication thereof, the recommended SAN architecture is of a breadth that covers a range of permissible implementations of a SAN, hence one or even a few SANshots are typically inadequate to represent the breadth of the recommended SAN architecture.

A comparison such as depicted by the flowchart of FIG. 8 would be carried out, e.g., by U-comparator 226. Rules, and optionally one or a few basic SANshots, characterizing the recommended SAN architecture are stored in customer validation knowledge base 218 of database 208. The adjective “customer” is used to contrast this copy of the validation knowledge base against the version available from the vendor of the recommended SAN architecture. The vendor's version of the knowledge base may have evolved relative to the instance of the recommended SAN architecture obtained by the customer.

In FIG. 8, flow begins at block 800 and proceeds to block 802, where a SANshot, S, to be validated and a value Q of the number of interconnected devices therein are automatically provided. Flow proceeds to block 804, where it is determined automatically whether M complies with a maximum number of devices MAX listed (e.g., in customer knowledge base 218) for the recommended SAN architecture. Flow proceeds to block 806.

In block 806, it is determined automatically whether attributes of a k^{th} device, Dk, are valid. Block 806 is iterated for each of the Q devices in S, or (in other words) is iterated over 1≦k≦Q. For example, block 806 can include: automatically determining if the type of device Dk is acceptable based upon a first listing of acceptable devices comprised included within knowledge base 218; and automatically determining, at least for each device Dk found to be permissible, whether instance details thereof are permissible based upon a second listing of permissible instances of device types included within customer knowledge base 218. Additional evaluation of hardware and software attributes have been discussed above.

Flow proceeds to block 808 from block 806. At block 808, it is determined automatically whether links of a kth device, Dk, are valid. Block 808 is iterated for each link of each of the Q devices in S, or (in other words) is iterated over 1≦k≦Q. For example, block 806 can include: automatically determining whether parameter values of the links of the device are permissible based upon a third listing of permissible topological parameter values for one or more of (A) at least one of the permissible device types and (B) at least one of the permissible instances thereof. Additional evaluation of link parameter values has been discussed above.

Flow proceeds to block 810 from block 808. At block 810, a SAN-level topology of the devices S as a whole is evaluated automatically. It should be observed that block 808, by contrast, can be described as a device-level evaluation of topology. Flow proceeds to block 812.

At block 812, the following can be performed automatically. A count ND(k) can be made of each instance of device type DC(k) in S, where k is a positive integer. Then it can be determined, for each device type DC(k), if the corresponding count ND(k) complies with a corresponding maximum permissible number of devices DMAX(k). Values of DMAX(k) can be stored, e.g., in customer knowledge base 218. Flow proceeds to block 814.

At block 814, the following can be performed automatically. A set P of all paths in S can be automatically computed. A hop-count HC(h) for each path PTH(h) can be automatically computed. Flow then proceeds to block 816.

At block 816, each hop-count HC(h) can be validated automatically. For example, this can be done by automatically indexing into a listing, e.g., in customer knowledge base 218, to obtain the maximum permissible hop-count HCMAX(k) for the device D(k). Then the maximum permissible hop-count HCMAX(k) can be automatically compared against the hop-count HC(h) of each path PTH(h) to determine it if is acceptable.

Flow proceeds from block 816 to block 818, where the validation results of blocks 804-816 automatically are provided to response generator 210, etc. Flow proceeds to block 726 and stops.

The methodologies discussed above can be embodied as a machine and/or on a machine-readable medium. Such a machine-readable medium can include code segments embodied thereon that, when read by a machine, cause the machine to perform the methodologies described above. Of course, although several variances and example embodiments of the present invention are discussed herein, it is readily understood by those of ordinary skill in the art that various additional modifications may also be made to the present invention. Accordingly, the example embodiments discussed herein are not limiting of the present invention.

What is claimed:

1. A method of modeling a storage system that includes an interconnected plurality of devices, there being at least one instance of a multi-link rather than a single-link between two of the plurality of devices, the method comprising:
providing a snapshot of the storage system (SSshot);
decomposing multi-links of the SSshot into single-link-based arrangements, respectively;
associating the single-link-based arrangements with the multi-links, respectively; and
modeling the storage system as a graph of singly-linked nodes based upon the SSshot and the associated single-link-based arrangements, where nodes of the graph correspond to the plurality of devices.

2. The method of claim 1, wherein:
the decomposing of each multi-link includes the following,
making a count of the number of links in the multi-link,
treating the multi-link as a fictional single-link, and
associating the count with the fictional single-link; and
each single-link-based arrangement accordingly includes a fictional single-link and an associated count.

3. The method of claim 1, wherein:
each multi-link connects a pair of nodes;
the decomposing of each multi-link includes the following,
representing the pair of nodes as a plurality of pairs of fictional sub-nodes, where each link is allotted to one of the plurality of fictional sub-node pairs, respectively, each pair of fictional sub-nodes having a single-link therebetween, and
associating the singly-linked fictional sub-node pairs with the multi-link; and
each single-link-based arrangement includes a plurality of the singly-linked fictional sub-node pairs.

4. A method of comparing a first snapshot of a storage system against a second snapshot thereof (SSshot), the storage system including an interconnected first plurality of devices as of the first SSshot and an interconnected second plurality of devices as of the second SSshot, the method comprising:
automatically comparing at least first attribute values for devices of the second SSshot against at least first attribute values for devices of the first SSshot; and
automatically identifying at least one of the following,
any such attribute values for devices in the second SSshot that match corresponding attribute values for devices in the first SSshot,
any such attribute values for devices in the second SSshot that are not present amongst corresponding attribute values for devices in the first SSshot, and
any such attribute values for devices in the first SSshot that are not present amongst the at least first values in the second SSshot.

5. The method of claim 4, wherein the first attribute is a unique identification (UID) that is unique at least within the storage system.

6. The method of claim 4, further comprising:
automatically providing, for each identified UID value, a corresponding indication thereof.

7. The method of claim 4, wherein:
the automatic identification of matching UID values is performed; and
the method further comprises the following,
(A) automatically comparing, for each matching UID value, at least one of links to and a value for a second attribute of the corresponding device as indicated by the second SSshot against links to and a value for the second attribute of the corresponding device as indicated by the first SSshot, respectively; and
(B) automatically identifying, for each matching UID value, at least one of the following,
(1) links to the corresponding device as indicated by the second SSshot that match links to the corresponding device as indicated by the first SSshot,
(2) the value for the second attribute of the corresponding device as indicated by the second SSshot where there is a match with the value for the second attribute of the corresponding device as indicated by the first SSshot,
(3) one or more of the links to the corresponding device as indicated by the second SSshot that are not present among the links to the corresponding device as indicated by the first SSshot,
(4) the value for the second attribute of the corresponding device as indicated by the second SSshot where there is no match with the value for the second attribute of the corresponding device as indicated by the first SSshot, and
(5) the value for the second attribute of the corresponding device as indicated by the first SSshot where there is no match with the value for the second attribute of the corresponding device as indicated by the second SSshot.

8. The method of claim 7, further comprising:
automatically providing, for each matching UID value and for each respective matching link and value of the second attribute, corresponding indications thereof.

9. The method of claim 7, wherein:
the automatic comparison of links for matching UID values is performed;
each link can be viewed as connecting a domestic port and a counterpart port, the domestic port being a port of a domestic device corresponding to the matching UID, and the counterpart port being a port on a counterpart device to which the domestic device is connected via the link; and
the automatic comparison of links includes the following,
comparing, for each matching UID and for each link thereof, one or more of the domestic port type, the domestic port number, a UID of the counterpart device, the counterpart port type and the counterpart port number as indicated by the second SSshot against what is indicated by the first SSshot, respectively;
the automatic identification includes automatically identifying, for each matching UID and for each link thereof, at least one of the following,
(1) one or more of the domestic port types, the domestic port numbers, the UID of the counterpart device, the counterpart port types and the counterpart port numbers indicated by the second SSshot that match what is indicated by the first SSshot, respectively,
(2) one or more of the domestic port types, the domestic port numbers, the UID of the counterpart device, the counterpart port types and the counterpart port numbers indicated by the second SSshot that are not present among the port types indicated by the first SSshot, and
(3) one or more of the domestic port types, the domestic port numbers, the UID of the counterpart device, the counterpart port types and the counterpart port numbers indicated by the first SSshot that are not present among the port types indicated by the second SSshot.

10. The method of claim 4, wherein:
there is, for at least one of the first SSshot and the second SSshot, at least one instance of a multi-link rather than a single link between two of the plurality of devices; and
the method further comprises the following,
decomposing multi-links into single-link-based arrangements, respectively,
associating the single-link-based arrangements with the multi-links, respectively; and
modeling each of the first and second SSshots as first and second graphs of singly-linked nodes, respectively, based upon the first and second SSshots and the associated single-link-based arrangements, respectively, where nodes of each graph correspond to the respective plurality of devices.

11. The method of claim 10, wherein:
the decomposing of each multi-link includes the following,
making a count of the number of links in the multi-link,
treating the multi-link as a fictional single-link, and
associating the count with the fictional single-link; and
each single-link-based arrangement accordingly includes a fictional single-link and an associated count.

12. The method of claim 10, wherein:
each multi-link connects a pair of nodes;
the decomposing of each multi-link includes the following,
representing the pair of nodes as a plurality of pairs of fictional sub-nodes, where each link is allotted to one of the plurality of fictional sub-node pairs, respectively, each pair of fictional sub-nodes having a single-link therebetween, and
associating the singly-linked fictional sub-node pairs with the multi-link; and
each single-link-based arrangement includes a plurality of the singly-linked fictional sub-node pairs.

13. An apparatus for modeling a storage system that includes an interconnected plurality of devices, there being at least one instance of a multi-link rather than a single-link between two of the plurality of devices, the apparatus comprising:
snapshot means for providing a snapshot of the storage system (SSshot);
decomposition means for decomposing multi-links of the SSshot into single-link-based arrangements, respectively;
association means associating the single-link-based arrangements with the multi-links, respectively; and
modeler means for modeling the storage system as a graph of singly-linked nodes based upon the SSshot and the associated single-link-based arrangements, where nodes of the graph correspond to the plurality of devices.

14. The apparatus of claim 13, wherein:
the decomposition means also is operable upon each multi-link so as to include doing the following,
making a count of the number of links in the multi-link,
treating the multi-link as a fictional single-link, and
associating the count with the fictional single-link; and
each single-link-based arrangement accordingly includes a fictional single-link and an associated count.

15. The apparatus of claim 13, wherein:
each multi-link connects a pair of nodes;
the decomposition means also is operable upon each multi-link so as to include doing the following,
representing the pair of nodes as a plurality of pairs of fictional sub-nodes, where each link is allotted to one of the plurality of fictional sub-node pairs, respectively, each pair of fictional sub-nodes having a single-link therebetween, and
associating the singly-linked fictional sub-node pairs with the multi-link; and
each single-link-based arrangement includes a plurality of the singly-linked fictional sub-node pairs.

16. A machine-readable medium including instructions, execution of which by a machine models a storage system that includes an interconnected plurality of devices, there being at least one instance of a multi-link rather than a single-link between two of the plurality of devices, the machine-readable instructions comprising:
a first code segment to provide a snapshot of the storage system (SSshot);
a second code segment to decompose multi-links of the SSshot into single-link-based arrangements, respectively;
a third code segment to associate the single-link-based arrangements with the multi-links, respectively; and
a fourth code segment to model the storage system as a graph of singly-linked nodes based upon the SSshot and the associated single-link-based arrangements, where nodes of the graph correspond to the plurality of devices.

17. The machine-readable instructions of claim 16, wherein:
execution of the second code segment further renders the machine operable upon each multi-link so as to include doing the following,
making a count of the number of links in the multi-link,
treating the multi-link as a fictional single-link, and
associating the count with the fictional single-link; and
each single-link-based arrangement accordingly includes a fictional single-link and an associated count.

18. The machine-readable instructions of claim 16, wherein:
each multi-link connects a pair of nodes;
execution of the second code segment further renders the machine operable upon each multi-link so as to include doing the following,
representing the pair of nodes as a plurality of pairs of fictional sub-nodes, where each link is allotted to one of the plurality of fictional sub-node pairs, respectively, each pair of fictional sub-nodes having a single-link therebetween, and
associating the singly-linked fictional sub-node pairs with the multi-link; and
each single-link-based arrangement includes a plurality of the singly-linked fictional sub-node pairs.

19. An apparatus for comparing a first snapshot of a storage system against a second snapshot thereof (SSshot), the storage system including an interconnected first plurality of devices as of the first SSshot and an interconnected second plurality of devices as of the second SSshot, the apparatus comprising:
comparison means for automatically comparing at least first attribute values for devices of the second SSshot against at least first attribute values for devices of the first SSshot; and
ID means for automatically identifying at least one of the following,
any such attribute values for devices in the second SSshot that match corresponding attribute values for devices in the first SSshot,
any such attribute values for devices in the second SSshot that are not present amongst corresponding attribute values for devices in the first SSshot, and
any such attribute values for devices in the first SSshot that are not present amongst the at least first values in the second SSshot.

20. The apparatus of claim 19, wherein the first attribute is a unique identification (UID) that is unique at least within the storage system.

21. The apparatus of claim 19, further comprising:
output means for automatically providing, for each identified UID value, a corresponding indication thereof.

22. The apparatus of claim 19, wherein:
the ID means is operable for automatically identifying matching UID values; and
the ID means is further operable for doing the following,
(A) automatically comparing, for each matching UID value, at least one of links to and a value for a second attribute of the corresponding device as indicated by the second SSshot against links to and a value for the second attribute of the corresponding device as indicated by the first SSshot, respectively; and
(B) automatically identifying, for each matching UID value, at least one of the following,
(1) links to the corresponding device as indicated by the second SSshot that match links to the corresponding device as indicated by the first SSshot,
(2) the value for the second attribute of the corresponding device as indicated by the second SSshot where there is a match with the value for the second attribute of the corresponding device as indicated by the first SSshot,
(3) one or more of the links to the corresponding device as indicated by the second SSshot that are not present among the links to the corresponding device as indicated by the first SSshot,
(4) the value for the second attribute of the corresponding device as indicated by the second SSshot where there is no match with the value for the second attribute of the corresponding device as indicated by the first SSshot, and
(5) the value for the second attribute of the corresponding device as indicated by the first SSshot where there is no match with the value for the second attribute of the corresponding device as indicated by the second SSshot.

23. The apparatus of claim 22, further comprising:
output means for automatically providing, relative to each matching UID value and relative to each respective matching link and value of the second attribute, corresponding indications thereof.

24. A machine-readable medium including instructions, execution of which by a machine of compares a first snapshot of a storage system against a second snapshot thereof (SSshot), the storage system including an interconnected first plurality of devices as of the first SSshot and an interconnected second plurality of devices as of the second SSshot, the machine-readable instructions comprising:
a first code segment to automatically compare at least first attribute values for devices of the second SSshot against at least first attribute values for devices of the first SSshot; and
a second code segment to automatically identify at least one of the following,
any such attribute values for devices in the second SSshot that match corresponding attribute values for devices in the first SSshot,
any such attribute values for devices in the second SSshot that are not present amongst corresponding attribute values for devices in the first SSshot, and
any such attribute values for devices in the first SSshot that are not present amongst the at least first values in the second SSshot.

25. The machine-readable instructions of claim 24, wherein the first attribute is a unique identification (UID) that is unique at least within the storage system.

26. The machine-readable instructions of claim 24, further comprising:
a third code segment to automatically provide, for each identified UID value, a corresponding indication thereof.

27. The machine-readable instructions of claim 24, wherein:
execution of the first code segment further renders the machine operable to automatically identify matching UID values; and
the machine-readable instructions further comprises the following,
a third code segment to automatically compare, for each matching UID value, at least one of links to and a value for a second attribute of the corresponding device as indicated by the second SSshot against links to and a value for the second attribute of the corresponding device as indicated by the first SSshot, respectively; and
a fourth code segment to automatically identify, for each matching UID value, at least one of the following,
(1) links to the corresponding device as indicated by the second SSshot that match links to the corresponding device as indicated by the first SSshot,
(2) the value for the second attribute of the corresponding device as indicated by the second SSshot where there is a match with the value for the second attribute of the corresponding device as indicated by the first SSshot,
(3) one or more of the links to the corresponding device as indicated by the second SSshot that are not present among the links to the corresponding device as indicated by the first SSshot,
(4) the value for the second attribute of the corresponding device as indicated by the second SSshot where there is no match with the value for the second attribute of the corresponding device as indicated by the first SSshot, and
(5) the value for the second attribute of the corresponding device as indicated by the first SSshot where there is no match with the value for the second attribute of the corresponding device as indicated by the second SSshot.

28. The machine-readable instructions of claim 27, further comprising:
a fifth code segment to automatically provide automatically providing, for each matching UID value and for each respective matching link and value of the second attribute, corresponding indications thereof.

29. A machine configured to implement the method of claim 1.

30. A machine configured to implement the method of claim 4.
